(19) United States
(12) Patent Application Publication
(10) Pub. No.: US 2009/0071954 A1
(43) Pub. Date: Mar. 19, 2009

(54) Induction Tempering Method, Induction Tempering Apparatus, and Induction Tempered Product

(76) Inventors: Takumi Fujita, Mie (JP); Nobuyuki Suzuki, Mie (JP)

Correspondence Address: MCDERMOTT WILL & EMERY LLP, 600 13TH STREET, N.W., WASHINGTON, DC, 20005-3096, US

(21) Appl. No.: 11/991,909

(22) PCT Filed: Jul. 28, 2006
(86) PCT No.: PCT/JP2006/315013

§ 371 Date: Mar. 12, 2008

(30) Foreign Application Priority Data
Sep. 12, 2005 (JP) 2005-263845

(51) Int. Cl. H05B 6/02

(52) U.S. Cl. 219/600

(57) ABSTRACT

An induction tempering method allowing the tempering condition to be determined readily and the quality of a workpiece stabilized includes a heating temperature control step, and a heating time control step. The heating temperature control step includes a heating temperature control related temperature measurement step, a heating temperature adjustment step, and a heating step. The heating time control step includes a heating time control related temperature measurement step, a heating time adjustment step, and a heating end step. At the heating time adjustment step, a tempering time t to determine the timing in ending heating of the workpiece is calculated based on the following equation (A).

H=a·log(t)+b·(1/T)+c (A)
H: hardness of workpiece; t: tempering time; T: temperature of workpiece; a, b, c: constant.

### TECHNICAL FIELD

The present invention relates to an induction tempering method, an induction tempering apparatus, and an induction tempered product. More particularly, the present invention relates to an induction tempering method for tempering a workpiece by heating through high-frequency induction heating, an induction tempering apparatus for tempering a workpiece by heating through high-frequency induction heating, and an induction tempered product subjected to induction tempering.

### BACKGROUND ART

Steel products subjected to quench-hardening often undergo a tempering process for the purpose of improving the toughness and dimensional stability. The tempering temperature for the tempering process is determined based on the type of steel of the base material constituting the steel product. The tempering time is not so critically determined as the tempering temperature, and is generally adjusted more or less in view of the size, thickness, and the like of the steel product. This is because the tempering temperature has a governing influence on the tempering effect whereas the tempering time is less effective than the tempering temperature.

It is conventionally known that the tempering parameter P indicating the tempering effect is determined by the equation (1) set forth below (J. H. Hollomon and L. D. Jaffe Trans. Met. soc. AIME, 162, 1945, p. 223 (Non-Patent Document 1)).

P=T{log(t)+C} (1)

t: time, T: temperature, C: constant

Equation (1) represents the tempering temperature and tempering time required to obtain a predetermined tempering effect. As a more practical equation, there is a known equation (2) representing the relationship of the material (hardness) with respect to the tempering temperature and time (Inoue, “Tetsu-to-Hagane (Iron and Steel)” vol. 66, 1980, p. 1532, (Non-Patent Document 2)).

H=a·log(t)+b·(1/T)+c (2)

H: hardness of workpiece; t: tempering time; T: temperature of workpiece (tempering temperature); a, b, c: constant

In order to carry out the tempering process efficiently, a likely strategy is to increase the tempering temperature and shorten the tempering time, i.e. employ the tempering condition of high temperature and short time. The tempering temperature and tempering time required to obtain a desired tempering effect can be calculated from the aforementioned equation (1) or (2), allowing determination of the tempering condition of high temperature and short time. In practice, however, the tempering condition of high temperature and short time is not generally employed in a tempering process. The reason is set forth below. Typically, the tempering process is often carried out simultaneously for a plurality of workpieces. In this case, the temperature of the workpieces in the furnace where the tempering process is effected will vary depending upon the shape, amount, and the like of the workpieces, leading to difference in the tempering effect between the workpieces processed at the same time. As a result, the quality of the workpieces subjected to tempering will vary. In order to avoid such variation in the quality of the workpieces, the tempering condition of relatively low temperature and long time that does not readily cause variation in the tempering effect is often employed in the tempering process.

As a heat treatment method suitable for the tempering process of high temperature and short time, there is known a high-frequency heating process of heat treatment based on carrying out heating utilizing high-frequency induction heating (induction heating) on a workpiece-by-workpiece basis or in small units of the workpiece. Induction tempering identified as tempering based on rapid heating utilizing high-frequency induction heating has been reported to allow application of superior property to the workpiece, as compared to general tempering employing a normal-controlled atmosphere furnace (Kawasaki et al., “Tetsu-to-Hagane (Iron and Steel)” vol. 74, 1988, p. 334 (Non-Patent Document 3) and Kawasaki et al., “Tetsu-to-Hagane (Iron and Steel)” vol. 74, 1988, p. 342 (Non-Patent Document 4)).

Non-Patent Document 1: J. H. Hollomon and L. D. Jaffe, Trans. Met. soc. AIME, 162, 1945, p. 223

Non-Patent Document 2: Inoue, “Tetsu-to-Hagane (Iron and Steel)”, vol. 66, 1980, p. 1532

Non-Patent Document 3: Kawasaki et al. “Tetsu-to-Hagane (Iron and Steel)”, vol. 74, 1988, p. 334

Non-Patent Document 4: Kawasaki et al. “Tetsu-to-Hagane (Iron and Steel)”, vol. 74, 1988, p. 342

### DISCLOSURE OF THE INVENTION

### Problems to be Solved by the Invention

At present, it cannot be said that induction tempering is a tempering method generally used extensively. The reason will be described hereinafter. Typically in induction heat treatment, heating is effected while altering the power applied to the induction coil used for heating and the duration thereof, followed by identifying the quality of the workpiece subjected to heat treatment. It is necessary to determine the heat treatment condition empirically based on the identified quality. If the shape, base material, and the like of the workpiece change in the induction tempering process, the tempering condition must be determined again at each change. There was a problem that determination of the tempering condition requires experience and is bothersome. There is a demand for an induction tempered product, reduced in the fabrication cost and having stable quality, by overcoming the aforementioned problem and facilitating determination of the tempering condition.

In view of the foregoing, an object of the present invention is to provide an induction tempering method and induction tempering apparatus allowing the tempering condition to be determined readily and the quality of the workpiece stabilized. Another object of the present invention is to provide an induction tempered product reduced in the fabrication cost and having stable quality.

### Means for Solving the Problems

An induction tempering method of the present invention for tempering a workpiece by heating through high-frequency induction heating includes a heating temperature control step of adjusting the heating temperature of a workpiece, and a heating time control step of adjusting the heating time of the workpiece. The heating temperature control step includes a heating temperature control related temperature measurement step of measuring the temperature of the workpiece to output temperature data, a heating temperature adjustment step of providing a heating temperature control signal to adjust the heating temperature of the workpiece based on the temperature data output in the heating temperature control related temperature measurement step, and a heating step of heating the workpiece by high-frequency induction heating based on the heating temperature control signal output at the heating temperature adjustment step. The heating time control step includes a heating time control related temperature measurement step of measuring the temperature of the workpiece to output temperature data, a heating time adjustment step of determining the timing in ending heating of the workpiece based on temperature data output at the heating time control related temperature measurement step to output a heating end signal, and a heating end step of ending heating of the workpiece based on the heating end signal output at the heating time adjustment step. In the heating time adjustment step, the tempering time t to determine the timing in ending heating of the workpiece is calculated based on an equation (A) set forth below.

H=a·log(t)+b·(1/T)+c (A)

H: hardness of workpiece; t: tempering time; T: temperature of workpiece; a, b, c: constant.

Generally in induction heat treatment, first the transition of the power source output (power source output pattern) based on the parameters of power and time is determined as the heating condition (power control). The power source output pattern is determined by actually applying heat treatment on samples of workpieces with the power and time varied while taking into account the shape, material, and the like of the workpiece, and then identifying the quality of the workpiece subjected to heat treatment. Therefore, determination of the power source output pattern requires experience and is bothersome. During the tempering step of a steel product, the workpiece must be maintained at a predetermined temperature for a predetermined time. However, it was difficult to accurately identify the heating history of the workpiece by the method set forth above (power control). Therefore, the power source output pattern was determined by way of experiment. Thus, the problems of not being able to identify accurately the heating history of the workpiece and that determination of the power source output pattern requires experience and is bothersome are noted in induction tempering.

In the induction tempering method of the present invention, the tempering temperature of the workpiece is controlled based on the temperature of the workpiece actually measured in the heating temperature control step, and the tempering time is controlled based on the temperature of the workpiece actually measured in the heating time control step. According to the induction tempering method of the present invention, heating of the workpiece (tempering) is controlled based on the parameters of temperature and time (temperature control). Therefore, the heating history of the workpiece can be identified accurately, and appropriate tempering can be effected by applying the required heating history to the workpiece.

According to the induction tempering method of the present invention, the tempering time t to determine the timing in ending heating of the workpiece is calculated based on the aforementioned equation (A) in the heating time adjustment step. Therefore, the timing in ending heating can be determined based on the relationship of tempering temperature T and tempering time t that are parameters in the induction tempering method of the present invention to the desired hardness H of the workpiece. Appropriate tempering can be conducted without having to evaluate the hardness and the like of a workpiece obtained by actually carrying out heat treatment. As a result, an induction tempering method allowing the tempering condition to be determined readily and the quality of the workpiece stabilized can be provided in the present invention.

Preferably in the induction tempering method of the present invention, the temperature of a plurality of sites of the workpiece is measured for output of plurality of temperature data based on the measured temperature in the heating time control related temperature measurement step, and the timing in ending heating of the workpiece is determined based on the plurality of temperature data to output a heating end signal in the heating time adjustment step.

Thus, the quality of the workpiece can be further stabilized since the tempering time can be determined based on the temperature of a plurality of sites of the workpiece, even in the case where the temperature of the workpiece is uneven during heating.

The plurality of sites preferably include the site where the temperature becomes highest and the site where the temperature becomes lowest in consideration of the shape and the like of the workpiece. By determining the tempering time t such that the site where the temperature becomes highest and the site where the temperature becomes lowest of the workpiece both attain the desired tempering state, specifically to achieve the desired range of hardness, the quality of the workpiece can be further stabilized.

In the heating time adjustment step, the timing in ending heating of the workpiece may be determined for output of a heating end signal based on the temperature data output at the heating temperature control related temperature measurement step as an alternative to or in addition to the temperature data output at the heating time control related temperature measurement step. Accordingly, the temperature data output at the heating temperature control related temperature measurement step can be utilized, not only for adjustment of the heating temperature, but also for the adjustment of the heating time.

High-frequency induction heating refers to heating of a workpiece by the Joule heat caused by the eddy current induced within the workpiece by conducting alternating current to the coil (inductor) arranged adjacent to the workpiece and the heat corresponding to hysterisis loss.

According to an aspect of the present invention, an induction tempering apparatus for tempering a workpiece by heating through high-frequency induction heating includes a heating temperature control member to adjust the heating temperature of the workpiece, and a heating time control member to adjust the heating time of the workpiece. The heating temperature control member includes a heating temperature control related temperature measurement member, a heating temperature adjustment member, and a heating member. The heating temperature control related temperature measurement member measures the temperature of a workpiece to output temperature data. The heating temperature adjustment member is connected to the heating temperature control related temperature measurement member, and outputs a heating temperature control signal to adjust the heating temperature of the workpiece based on the temperature data output from the heating temperature control related temperature measurement member. The heating member is connected to the heating temperature adjustment member, and heats the workpiece through high-frequency induction heating based on the heating temperature control signal output from the heating temperature adjustment member.

The heating time control member includes a heating time control related temperature measurement member, a heating time adjustment member, and a heating end member. The heating time control related temperature measurement member measures the temperature of the workpiece to output temperature data. The heating time adjustment member is connected to the heating time control related temperature measurement member, and determines the timing in ending heating of the workpiece based on the temperature data output from the heating time control related temperature measurement member to output a heating end signal. The heating end member is connected to the heating time adjustment member, and ends heating of the workpiece based on the heating end signal output from the heating time adjustment member.

Further, the induction tempering apparatus of the present invention is characterized in that the tempering time t to determine the timing in ending heating of the workpiece is calculated based on equation (A) at the heating time adjustment member.

By employing the induction tempering apparatus of the present invention, the tempering temperature of the workpiece can be controlled based on the temperature of the workpiece actually measured by the heating temperature control member, and the tempering time can be controlled based on the temperature of the workpiece actually measured by the heating time control member. According to the induction tempering apparatus of the present invention, heating (tempering) of the workpiece can be controlled with the temperature and time as parameters (temperature control). By employing the induction tempering apparatus of the present invention, the heating history of the workpiece can be identified accurately, and appropriate tempering can be carried out by applying the required heating history to the workpiece.

In the induction tempering apparatus of the present invention, tempering time t directed to determining the timing in ending heating of the workpiece can be calculated based on equation (A) in the heating time adjustment member. Since the timing in ending heating can be determined based on the relationship of tempering temperature T and tempering time t to the desired hardness H of the workpiece, appropriate tempering can be carried out without having to identify the hardness and the like of workpieces obtained by actually carrying out heat treatment. As a result, an induction tempering apparatus allowing the tempering condition to be determined readily and the quality of the workpiece stabilized can be provided in the present invention.

Preferably in the induction tempering apparatus of the present invention, the heating time control member includes a plurality of heating time control related temperature measurement members. Accordingly, the temperature of a plurality of sites of a workpiece can be measured by the plurality of heating time control related temperature measurement members for output of a plurality of temperature data, and the timing in ending heating of a workpiece can be determined based on the plurality of temperature data in the heating time adjustment member to output a heating end signal. Therefore, the quality of the workpiece can be further stabilized since the tempering time can be determined based on the temperature of a plurality of sites of the workpiece even when there is temperature unevenness in the workpiece during heating.

Further, the heating time control related temperature measurement members set forth above preferably include, in consideration of the shape and the like of the workpiece, a heating time control related temperature measurement member arranged to allow temperature measurement at a site where the temperature becomes highest, and a heating time control related temperature measurement member arranged to allow temperature measurement at a site where the temperature becomes lowest.

Accordingly, by determining the tempering time such that the site where the temperature becomes highest and the site where the temperature becomes lowest of the workpiece both attain a desired tempering state, specifically to achieve a desired range of hardness, for example, the quality of the workpiece can be further stabilized.

The heating temperature control related temperature measurement member may also serve as the heating time control related temperature measurement member. Accordingly in the heating time adjustment member, the timing in ending heating of the workpiece can be determined to output a heating end signal based on temperature data output from the heating temperature control related temperature measurement member as an alternative to or in addition to the temperature data output from the heating time control related temperature measurement member. As a result, the temperature data output from the heating temperature control related temperature measurement member can be employed, not only for adjustment of the heating temperature, but also for adjustment of the heating time.

For the heating temperature control related temperature measurement member and heating time control related temperature measurement member, a non-contact type thermometer such as a radiation thermometer, or a contact type thermometer such as a thermocouple, if allowed from the standpoint of layout of the device, may be employed. Further, the heating temperature adjustment member is a computer such as a personal computer to conduct temperature adjustment by, for example, PID (Proportional Integral Differential) temperature control. The heating member includes a power source that can generate high-frequency current and a primary coil as an inductor, for example. In addition, the heating time adjustment member is a computer such as a personal computer that can execute software to calculate the tempering time t directed to determining the timing in ending heating of the workpiece based on equation (A), for example. The same device may serve as both the heating temperature adjustment member and heating time adjustment member. Further, the heating end member is, for example, a computer such as a personal computer that can execute software to stop heating by the heating member based on a heating end signal, for example. The same personal computer may serve as the heating temperature adjustment member and/or heating time adjustment member and heating end member. The heating end member may include a coolant liquid jet device for cooling the workpiece by spraying out coolant liquid such as coolant water towards the workpiece, or include a transfer device for ending heating of the workpiece through the heating member by moving the workpiece relative to the heating member to remove the workpiece from the region where heating by the heating member is allowed.

An induction tempered product according to the present invention corresponds to an induction tempered product subjected to tempering by the induction tempering method of the present invention set forth above employing the induction tempering apparatus of the present invention set forth above. According to an aspect of the present invention, an induction tempered product reduced in the fabrication cost since the tempering condition can be determined readily, and stabilized in quality since tempering is effected by temperature control, can be provided.

### EFFECTS OF THE INVENTION

According to the induction tempering method and induction tempering apparatus apparent from the description set forth above, an induction tempering method and induction tempering apparatus allowing the tempering condition to be determined readily and the quality of the workpiece stabilized can be provided. Furthermore, according to an aspect of the present invention, an induction tempered product reduced in the fabrication cost and stabilized in quality can be provided.

### BRIEF DESCRIPTION OF THE DRAWINGS

FIG. 1 is a schematic diagram showing a structure of an induction heat treatment apparatus according to an embodiment.

FIG. 2 schematically shows an induction tempering method according to an embodiment.

FIG. 3 is a diagram of conditions indicating the relationship between tempering temperature T and tempering time t required for an outer ring to satisfy the hardness standard, subsequent to the tempering process.

FIG. 4 is a diagram to describe a method of accumulating the hardness value of a workpiece from temperature transition, subsequent to tempering.

### DESCRIPTION OF THE REFERENCE SIGNS

1 workpiece (outer ring), 2 induction coil, 3 first radiation thermometer, 4 first personal computer, 5 second radiation thermometer, 6 second personal computer, 7 coolant water jet device.

### BEST MODES FOR CARRYING OUT THE INVENTION

Embodiments of the present invention will be described hereinafter based on the drawings. In the drawings, the same or corresponding elements have the same reference character number allotted, and description thereof will not be repeated.

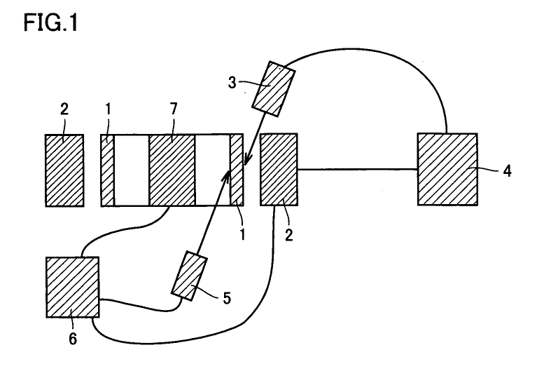

First, an induction heat treatment apparatus according to an embodiment of the present invention will be described with reference to FIG. 1. Referring to FIG. 1, an induction heat treatment apparatus of the present embodiment is directed to tempering a workpiece 1 by heating through high-frequency induction heating, and includes a heating temperature control member adjusting the heating temperature of workpiece 1 that is an outer ring or the like of a rolling bearing having a cylindrical shape, and a heating time control member adjusting the heating time of workpiece 1. The heating temperature control member includes a first radiation thermometer 3 as a heating temperature control related temperature measurement member, a first personal computer 4 as a heating temperature adjustment member, and an induction coil 2 (including a high-frequency power source) as the heating member. First radiation thermometer 3 functions to measure the temperature of workpiece 1 to output temperature data. First personal computer 4 is connected to first radiation thermometer 3, and functions to output a heating temperature control signal directed to adjusting the heating temperature of workpiece 1 by PID temperature control based on the temperature data output from first radiation thermometer 3. Induction coil 2 is connected to first personal computer 4, and functions to heat workpiece 1 through high-frequency induction heating based on the heating temperature control signal output from the first personal computer 4.

The heating time control member includes a second radiation thermometer 5 as a heating time control related temperature measurement member, a second personal computer 6 as a heating time adjustment member, and a coolant water jet device 7 as a heating end member. Second radiation thermometer 5 functions to measure the temperature of workpiece 1 to output temperature data. Second personal computer 6 is connected to second radiation thermometer 5, and functions to determine the timing in ending heating of workpiece 1 based on the temperature data output from second radiation thermometer 5 to output a heating end signal. Coolant water jet device 7 is connected to second personal computer 6, and functions to end heating of workpiece 1 by spraying out coolant water towards workpiece 1 to cool workpiece 1 based on the heating end signal output from second personal computer 6. Coolant water jet device 7 is connected, via a coolant water channel not shown, to a coolant water tank including a pump, and is configured to drive the pump based on the heating end signal output from second personal computer 6 to spray out coolant water from a coolant water outlet provided at the outer circumferential face. Second personal computer 6 is also connected to induction coil 2 identified as the heating member, and functions to output the above-described heating end signal also to induction coil 2 to end high-frequency induction heating. One personal computer may serve as first personal computer 4 and second personal computer 6.

Second personal computer 6 is stored with software directed to determining the timing in ending heating of workpiece 1 based on equation (A). Tempering time t to determine the timing in ending heating of a workpiece 1 can be calculated based on equation (A) by execution of the relevant software in second personal computer 6.

By employing the induction tempering apparatus of the present embodiment having the configuration set forth above, the tempering temperature of workpiece 1 can be controlled based on the temperature of workpiece 1 actually measured by the heating temperature control member, and the tempering time can be controlled based on the temperature of workpiece 1 actually measured by the heating time control member. As a result, the heating history of workpiece 1 can be identified accurately. By applying the required heating history to workpiece 1, appropriate tempering can be carried out.

According to the induction tempering apparatus of the present embodiment, appropriate tempering can be carried out without having to identify the hardness and the like of workpiece 1 obtained by actually carrying out heat treatment since tempering time t to determine the timing in ending heating of a workpiece 1 can be calculated based on the aforementioned equation (A) in second personal computer 6. As a result, the induction tempering apparatus of the present embodiment allows the tempering condition to be determined readily, and the quality of workpiece 1 to be stabilized.

The induction tempering apparatus of the present embodiment preferably includes a plurality of second radiation thermometers 5. Accordingly, the tempering time can be determined based on the temperature of a plurality of sites of workpiece 1 even when temperature unevenness occurs at workpiece 1 during heating. Therefore, the quality of workpiece 1 can be stabilized further.

In consideration of the shape and the like of workpiece 1, the plurality of second radiation thermometers 5 preferably include a second radiation thermometer 5 arranged to allow measurement of the temperature at a site where the temperature becomes highest, and a second radiation thermometer 5 arranged to allow measurement of the temperature at a site where the temperature becomes lowest.

Accordingly, by determining the tempering time such that the site where the temperature becomes highest and the site where the temperature becomes lowest of workpiece 1 both attain the desired tempering state, the quality of workpiece 1 can be stabilized further.

First radiation thermometer 3 may also serve as second radiation thermometer 5. Accordingly, the temperature data output from first radiation thermometer 3 can be employed, not only for adjustment of the heating temperature, but also for adjustment of the heating time.

The shape of induction coil 2 and the frequency of the power source in the present embodiment are not particularly limited, as long as workpiece 1 can be heated up to the tempering temperature. Although the present embodiment has been described corresponding to the case where first radiation thermometer 3 and second radiation thermometer 5 are employed as the heating temperature control related temperature measurement member and heating time control related temperature measurement member, the heating temperature control related temperature measurement member and heating time control related temperature measurement member of the present invention are not limited thereto, and a contact type thermometer such as a thermocouple may be employed, if allowed from the standpoint of layout of the induction tempering equipment.

An induction tempering method according to an embodiment of an induction tempering method of the present invention employing the induction tempering equipment of the present embodiment set forth above will be described hereinafter.

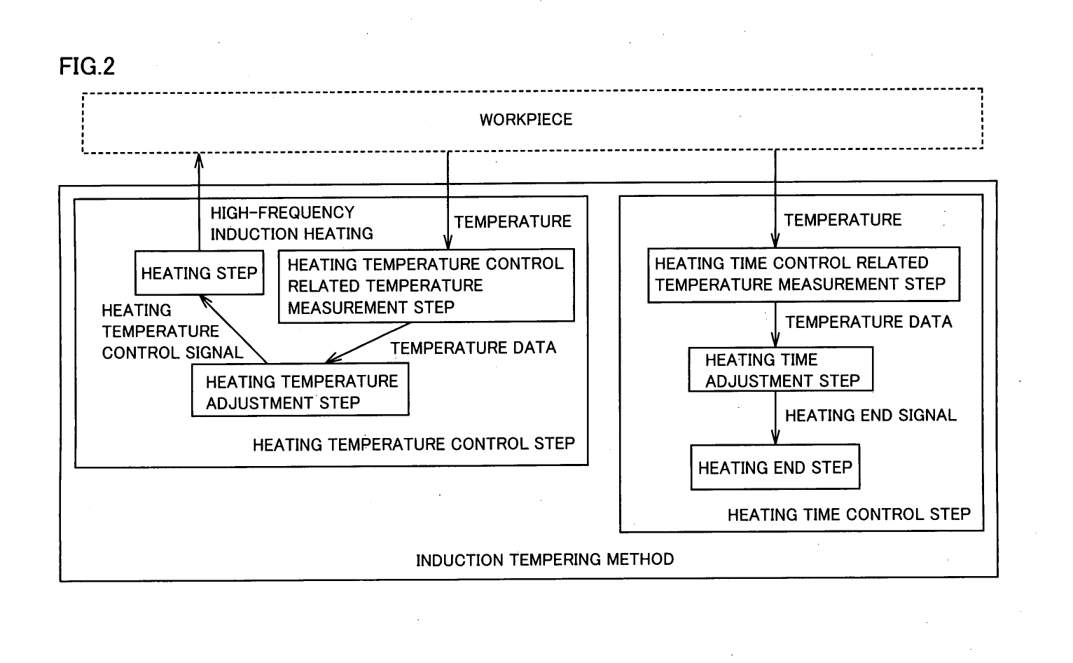

Referring to FIG. 2, an induction tempering method of the present embodiment for tempering a workpiece by heating through high-frequency induction heating includes a heating temperature control step of adjusting the heating temperature of the workpiece, and a heating time control step of adjusting the heating time of the workpiece.

Referring to FIGS. 1 and 2 in association with the heating temperature control step, first the temperature of workpiece 1 is measured by first radiation thermometer 3 and the temperature data is output in the heating temperature control related temperature measurement step. Then in the heating temperature adjustment step, a heating temperature control signal to adjust the heating temperature of workpiece 1 is output by first personal computer 4 using, for example, PID temperature control, based on the relevant temperature data. In the heating step, workpiece 1 is heated through high-frequency induction heating by means of induction coil 2 based on the heating temperature control signal.

At the heating time control step, the temperature of workpiece 1 is measured by second radiation thermometer 5, and temperature data is output in the heating time control related temperature measurement step. Then in the heating time adjustment step, the timing in ending heating of the workpiece is determined based on the temperature data and a heating end signal is output by second personal computer 6. Details of the method of determining the timing in ending heating will be described afterwards. In the heating end step, high-frequency induction heating effected by induction coil 2 is terminated based on the heating end signal, and coolant water is sprayed towards workpiece 1 from coolant water jet device 7 for cooling of workpiece 1. Thus, heating of workpiece 1 ends.

The details of the method to determine the timing in ending heating in the heating time adjustment step will be described with a rolling bearing 6206 type outer ring made of SUJ2 of JIS as workpiece 1. This workpiece 1 (outer ring 1) is quenched by being cooled down rapidly after being heated to 850° C. in an atmosphere furnace (RX gas atmosphere), and the hardness standard subsequent to the end of the tempering process is set to at least 58HRC and not more than 62HRC from the standpoint of strength and toughness.

The tempering temperature and tempering time required to satisfy the hardness standard set forth above can be calculated from equation (A).

H=a·log(t)+b·(1/T)+c (A)

H: hardness of workpiece; t: tempering time; T: temperature of workpiece; a, b, c: constant

Constants a, b and c in equation (A) are determined depending upon the material, and can be obtained empirically. For example, in the case where constants a, b and c are to be obtained for SUJ2 of JIS, a test piece made of SUJ2 subjected to quenching is prepared and maintained at a predetermined temperature for a predetermined time to effect tempering. Then, the hardness of the test piece subsequent to tempering is measured. Specifically, tempering is carried out under the conditions of five levels each for the practical temperature of 150° C. to 300° C. and the practical maintaining time of 2 minutes to 90 minutes corresponding to tempering of a product made of SUJ2, and the hardness of the test pieces subsequent to tempering is measured. The obtained results are applied to equation (A), and multiple linear regression analysis is carried out to determine constants a, b and c. Since constants a, b and c are determined depending upon the material, as mentioned above, equation (A) can be applied to the tempering of workpieces formed of various materials upon obtaining constants a, b and c for each material, allowing implementation of the present invention.

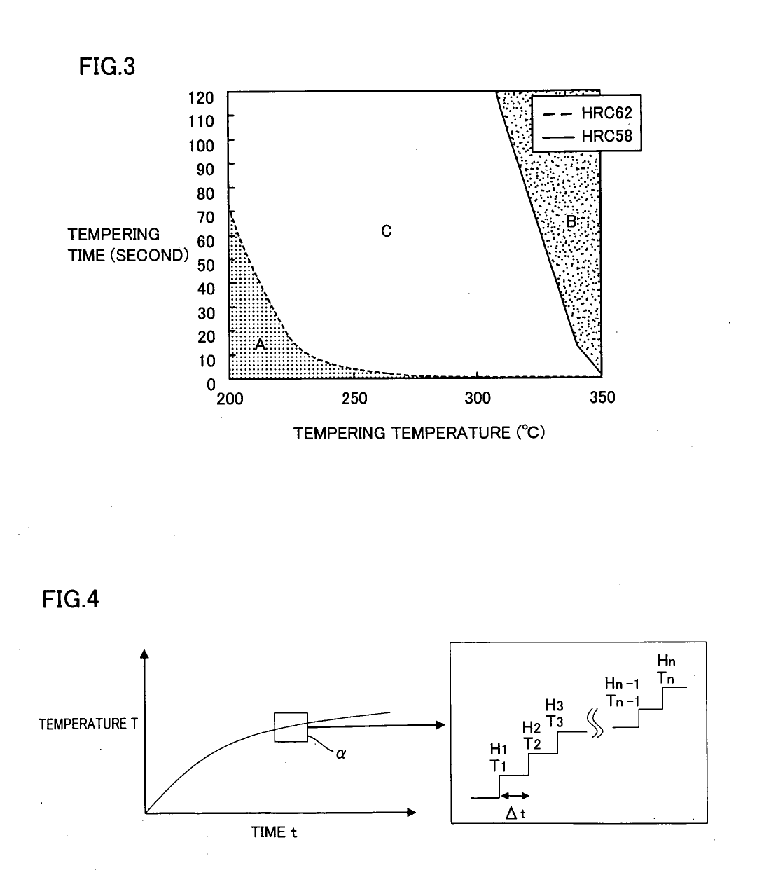

The method to determine the timing in ending heating in the heating time adjustment step will be described hereinafter. In FIG. 3, the horizontal axis represents the tempering temperature (° C.) and the vertical axis represents the tempering time (second). Region A corresponds to the range where the hardness of outer ring 1 subsequent to tempering is higher than 62HRC. Region B corresponds to the range lower than 58HRC, and region C corresponds to the range of 58 to 62HRC. The upper left graph in FIG. 4 represents the temperature transition with time t plotted along the horizontal axis and temperature T plotted along the vertical axis. The upper right drawing represents an enlargement of region a in the upper left graph. In addition, the lower section represents the equation to accumulate hardness H of outer ring 1 subsequent to tempering from the temperature transition. The method to determine the timing in ending heating at the heating time adjustment step will be described specifically with reference to FIGS. 3 and 4.

By ascertaining equation (A) upon obtaining constants a, b and c, there can be drawn a line diagram of conditions representing the relationship between tempering temperature T and tempering time t as shown in FIG. 3. The tempering condition can be obtained roughly from FIG. 3, allowing tempering at a shorter time as the tempering temperature becomes higher. It is therefore desirable to increase the tempering temperature from the standpoint of reducing the heat treatment time. However, in view of the likelihood of tempering unevenness due to temperature unevenness, the tempering temperature is determined taking into account the balance between the heat treatment time and tempering unevenness.

Upon determination of the tempering temperature, the heating pattern is input to first personal computer 4 shown in FIG. 1. A temperature control signal is output to induction coil 2 including a high-frequency power source by PID control based on the temperature data output from first radiation thermometer 3 to control the heating temperature of outer ring 1. At the same time, equation (A) is used to determine the timing in ending heating at second personal computer 6 based on the temperature data output from second radiation thermometer 5.

Since the temperature data from second radiation thermometer 5 varies from moment to moment, it is desirable to accumulate the value of H (hardness after tempering) for every short time Δt, as shown in FIG. 4 and in the following.

$${H}_{1} = a \cdot log Δ t + b \cdot \frac{1}{{T}_{1}} + c$$

$${H}_{1} = a \cdot log {t}_{1}^{*} + b \cdot \frac{1}{{T}_{2}} + c$$

$$from which {t}_{1}^{*} required for next calculation is calculated$$

$${H}_{2} = a \cdot log ( {t}_{1}^{*} + Δ t ) + b \cdot \frac{1}{{T}_{2}} + c$$

$${H}_{n} = a \cdot log ( {t}_{n - 1}^{*} + Δ t ) + b \cdot \frac{1}{{T}_{n}} + c$$

$${t}_{n}^{*} = {10}^{- a} \times {10}^{( {H}_{n} - \frac{b}{{T}_{n + 1}} - c )}$$

At the point of time when hardness H attains the desired value of at least 58HRC and not more than 62HRC, a heating end signal is output from second personal computer 6 to terminate heating of outer ring 1 effected by induction coil 2, and coolant water is sprayed out towards outer ring 1 from coolant water jet device 7 to cool outer ring 1. Thus, tempering ends.

According to the induction tempering method of the present embodiment, the heating history of outer ring 1 that is the workpiece can be identified accurately. By applying the required heating history to outer ring 1, appropriate tempering can be carried out. In the induction tempering method of the present embodiment, tempering time t to determine the timing in ending heating of a workpiece is calculated based on the aforementioned equation (A). Therefore, the tempering condition can be determined readily, and the quality of the workpiece can be rendered stable.

Thus, an induction tempering method according to an embodiment of the present invention is carried out employing the induction tempering apparatus according to an embodiment of the present invention. Outer ring 1 that is a workpiece is now identified as an induction tempered product according to an embodiment of the present invention.

Outer ring 1 that is an induction tempered product of the present embodiment is reduced in fabrication cost since the tempering condition can be determined readily, and has the quality stabilized since tempering is conducted based on temperature control.

Although a rolling bearing 6206 type outer ring made of SUJ2 of JIS was described as an example of an induction tempered product of the present invention, the induction tempered product of the present invention is not limited thereto. Namely, by determining constants a, b and c for each material as set forth above, equation (A) can be applied to tempering of workpieces formed of various materials to implement tempering. An induction tempered product of the present invention formed of various materials can be provided.

### EXAMPLE 1

An example of the present invention will be described hereinafter. Experiments to confirm the quality of workpieces subsequent to tempering were carried out, corresponding to various heat treatment conditions (tempering conditions) according to the induction tempering method and induction tempering equipment of the present invention. The procedure of the experiment will be described hereinafter. Using the induction tempering apparatus of FIG. 1 with the 6206 type outer ring made of SUJ2 of JIS as a workpiece, the induction tempering method of the present invention was conducted. It is to be noted that one radiation thermometer was employed for both first radiation thermometer 3 and second radiation thermometer 5 of FIG. 1. The experiments were carried out based on 100° C./second as the rate of increase in temperature during tempering, 240° C. to 300° C. as the highest temperature reached during tempering, 80 kHz as the frequency of the power source, and 60HRC as the target value of the hardness of the workpiece subsequent to tempering. The results of the experiments are shown in Table 1.

TABLE 1

| Heat Treatment Condition | | | |
|---|---|---|---|
| Highest | | | |
| Temperature | Rate of Increase | | |
| Reached | in Temperature | Hardness | Processing Time |
| (° C.) | (° C./sec) | (HRC) | (second) |
| 300 | 100 | 59.3~60.7 | 94 |
| 270 | 100 | 59.9~60.4 | 1495 |
| 240 | 100 | 59.9~60.1 | 5050 |

As indicated in Table 1, the tempering time (processing time) could be shortened significantly by increasing the tempering temperature (highest temperature reached). The range of variation in hardness (tempering unevenness) was slightly increased as the tempering temperature became higher. However, the range of variation in hardness was within the range of the hardness standard (at least 58HRC and not more than 62HRC) in all the tempering conditions. It is therefore appreciated that an appropriate tempering condition can be determined based on the balance between the tolerable range of tempering unevenness and reduction in fabrication cost by virtue of a shorter tempering time in view of the application of the workpiece.

From the results of the experiments, it was confirmed that an induction tempering method and induction tempering apparatus allowing the tempering condition to be determined readily and the quality of the workpiece stabilized can be provided by the present invention. Further, from the results of the experiments, it was confirmed that an induction tempered product reduced in the fabrication cost and stabilized in quality can be provided by the present invention.

It should be understood that the embodiments and examples disclosed herein are illustrative and non-restrictive in every respect. The scope of the present invention is defined by the terms of the claims, rather than the description above, and is intended to include any modification within the scope and meaning equivalent to the terms of the claims.

### INDUSTRIAL APPLICABILITY

The induction tempering method, induction tempering apparatus, and induction tempered product of the present invention can be advantageously applied to an induction tempering method and induction tempering equipment for tempering a workpiece by heating through high-frequency induction heating, and an induction tempered product tempered by being heated through high-frequency induction heating.

1. An induction tempering method for tempering a workpiece by heating through high-frequency induction heating, comprising:
a heating temperature control step of adjusting a heating temperature of said workpiece, and
a heating time control step of adjusting a heating time of said workpiece,
wherein said heating temperature control step comprises
a heating temperature control related temperature measurement step of measuring the temperature of said workpiece to output temperature data,
a heating temperature adjustment step of providing a heating temperature control signal to adjust the heating temperature of said workpiece based on said temperature data output at said heating temperature control related temperature measurement step, and
a heating step of heating said workpiece through high-frequency induction heating based on said heating temperature control signal provided at said heating temperature adjustment step,
wherein said heating time control step comprises
a heating time control related temperature measurement step of measuring the temperature of said workpiece to output temperature data,
a heating time adjustment step of determining a timing in ending heating of said workpiece based on said temperature data output at said heating time control related temperature measurement step to output a heating end signal, and
a heating end step of ending heating of said workpiece based on said heating end signal output at said heating time adjustment step,
wherein, at said heating time adjustment step, a heating time t to determine the timing in ending heating of said workpiece is calculated based on an equation of:
H=a·log(t)+b·(1/T)+c
H: hardness of workpiece; t: tempering time; T: temperature of workpiece; a, b, c: constant.

2. An induction tempered product subjected to tempering by the induction tempering method defined in claim 1.

3. An induction tempering apparatus for tempering a workpiece by heating through high-frequency induction heating, comprising:
a heating temperature control member to adjust a heating temperature of said workpiece, and
a heating time control member to adjust a heating time of said workpiece,
wherein said heating temperature control member comprises
a heating temperature control related temperature measurement member for measuring the temperature of said workpiece to output temperature data,
a heating temperature adjustment member connected to said heating temperature control related temperature measurement member to output a heating temperature control signal to adjust the heating temperature of said workpiece based on said temperature data output from said heating temperature control related temperature measurement member, and
a heating member connected to said heating temperature adjustment member to heat said workpiece through high-frequency induction heating based on said heating temperature control signal output from said heating temperature adjustment member,
wherein said heating time control member comprises
a heating time control related temperature measurement member to measure the temperature of said workpiece to output temperature data,
a heating time adjustment member connected to said heating time control related temperature measurement member to determine a timing in ending heating of said workpiece based on said temperature data output from said heating time control related temperature measurement member to output a heating end signal, and
a heating end member connected to said heating time adjustment member to end heating of said workpiece based on said heating end signal output from said heating time adjustment member,
wherein, at said heating time adjustment member, a heating time t to determine the timing in ending heating of said workpiece is calculated based on an equation of:
H=a·log(t)+b·(1/T)+c
H: hardness of workpiece; t: tempering time; T: temperature of workpiece; a, b, c: constant.

4. The induction tempering apparatus according to claim 3, comprising a plurality of said heating time control related temperature measurement members.
